(19) United States
(12) Patent Application Publication
(10) Pub. No.: US 2004/0188517 A1
(43) Pub. Date: Sep. 30, 2004

(54) Drink dispensing apparatus

(75) Inventor: Cheol-Ho Choi, Gwangju-city (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 10/614,021

(22) Filed: Jul. 8, 2003

(30) Foreign Application Priority Data
Mar. 31, 2003 (KR) 2003-19923

(51) Int. Cl. G06F 7/08

(52) U.S. Cl. 235/381

(57) ABSTRACT

Disclosed is a drink dispensing apparatus including a body having a drink discharge opening, a disposable sachet discharge opening, and a cup discharge opening, a cold/hot water supplying unit mounted in the body to supply cold water and hot water through the drink discharge opening, a disposable sachet supplying unit formed in the body for supplying a disposable sachet containing a premix beverage through the disposable sachet discharge opening, a cup supplying unit formed in the body for supplying a cup through the cup discharge opening, an ice making unit formed in the body for supplying an ice through the drink discharge opening, a cooling unit connected with the ice making unit, and a control unit for controlling the respective units. Accordingly, various drinks, such as cold water, hot water, cold drink, hot drink, water with ice, and drinks with ice, can be provided as desired by the customer.

### BACKGROUND OF THE INVENTION

1. Field of the Invention

The present invention relates to a drink dispensing apparatus, and more particularly, to a drink dispensing apparatus which respectively dispenses a disposable sachet containing premix beverage therein, a cup and drinkable water, thereby conveniently providing customers with various types of beverages.

2. Description of the Prior Art

A general drink dispensing apparatus such as the ones of the Office Coffee Service (OCS) operator provide the employees of office or customers of restaurants with drinks such as coffee or tea, by discharging coffee or tea granules from a predetermined reservoir along with aqueous drink into a cup.

Being mainly designed to dispense hot drinks, such a drink dispensing apparatus usually does not provide cold drinks or ice, and accordingly, it could not fully satisfy various demands of the users.

Furthermore, the conventional coffee or tea dispensers were not able to dispense water alone, and accordingly, a separate cold/hot water dispenser or an ice maker needed to be equipped in order to serve hot or cold water.

### SUMMARY AND OBJECTS OF THE INVENTION

Accordingly, it is an object of the present invention to provide a drink dispensing apparatus which is capable of dispensing various drinks such as hot drink, cold drink, drink with ice, hot water or water with ice, thus satisfying various demands of the customers. It is another object of the invention to provide a drink dispensing apparatus that dispenses a disposable sachet containing premixed beverages and eliminates the need for cleaning, thereby providing advantages such as hygienic environment and convenient upkeep and maintenance.

In order to achieve the above objects and features of the present invention, a drink dispensing apparatus includes a body having a drink discharge opening, a disposable sachet discharge opening, and a cup discharge opening, a cold/hot water supplying unit mounted in the body to supply cold water and hot water through the drink discharge opening, a disposable sachet supplying unit formed in the body for supplying a disposable sachet containing a premix beverage through the disposable sachet discharge opening, a cup supplying unit formed in the body for supplying a cup through the cup discharge opening, an ice making unit formed in the body for supplying an ice through the drink discharge opening, a cooling unit connected with the ice making unit, and a control unit for controlling the respective units.

Further provided is a water reservoir for supplying water to the cold/hot water supplying unit and the ice making unit.

The water reservoir is connected to an external water supply system through a water supply valve.

The water reservoir is provided with a water level sensor for sensing the water level of the water reservoir, the water level of the water reservoir being automatically adjusted in accordance with opening and closing of the water supply valve by the water level sensor.

The water reservoir includes a water tank connecting opening for receiving an external water supply.

As an option, a money unit may be additionally provided for receiving money, and the control unit can be entirely or partially operated only in response to the insertion of a predetermined amount of money through the money unit.

Further provided are a first selection button unit for selectively discharging the cold water and the hot water stored in the cold/hot water supplying unit and the ice stored in the ice making unit, and a second selection button unit for selecting the disposable sachet containing a premix beverage which is stored in the disposable sachet supplying unit.

With these and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

The above aspects and other features of the present invention will become more apparent by describing in detail a preferred embodiment thereof with reference to the attached drawings, in which:

FIG. 1 is a front elevation view illustrating the structure of a drink dispensing apparatus according to a preferred embodiment of the present invention;

FIG. 2 is a schematic view illustrating the water feeding system of the drink dispensing apparatus of FIG. 1;

FIG. 3 is a schematic view illustrating a flow of refrigerant in a cooling unit of the drink dispensing apparatus of FIG. 1; and

FIG. 4 is a block diagram of the drink dispensing apparatus of FIG. 1.

### DETAILED DESCRIPTION OF THE PREFERRED EMBODIMENT

Hereinafter, the present invention will be described in detail with reference to the accompanying drawings.

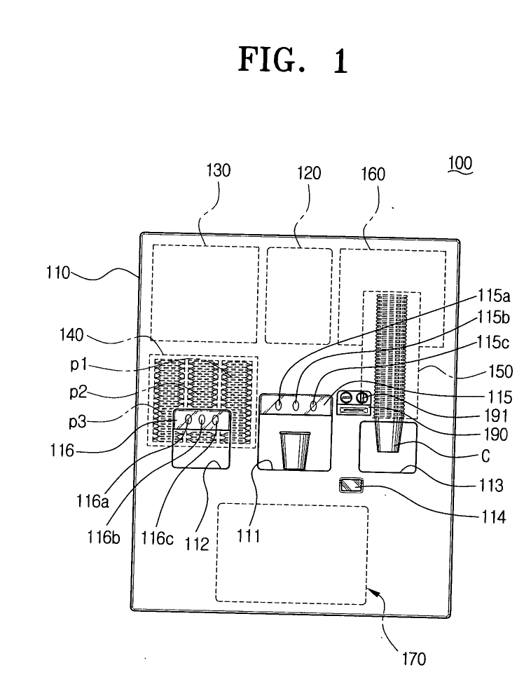

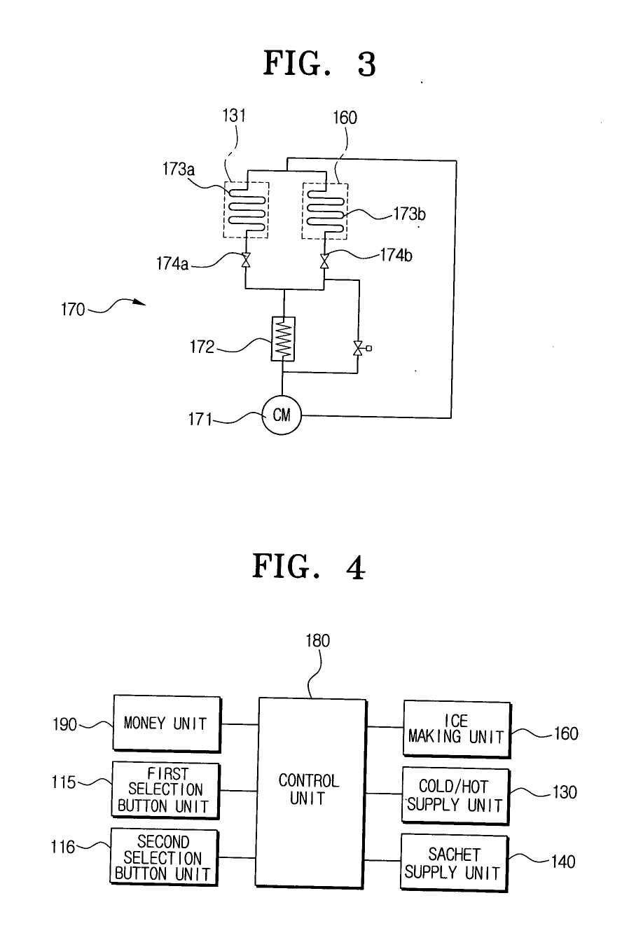

As shown in FIGS. 1 to 4, a drink dispensing apparatus 100 according to the present invention includes a body 110, a water reservoir 120, a cold/hot water supplying unit 130, a disposable sachet supplying unit 140, a cup supplying unit 150, an ice making unit 160, a cooling unit 170 and a control unit 180 (FIG. 4).

The body 110 is provided with a drink discharge opening 111 through which cold/hot water and ice are discharged from the cold/hot water supplying unit 130 and the ice making unit 160, a disposable sachet discharge opening 112 through which the disposable sachet containing premix beverage is discharged from the disposable sachet supplying unit 140, and a cup discharge opening 113 through which a cup is discharged from a stack of plural nested cups of the cup supplying unit 150.

Additionally, at a side of the body 110, there may be provided a money unit 190 through which coin and/or money bill is inserted, and at a lower portion of the money unit 190, there may be a change returning opening 114.

Formed on the outer surface of the body 110 are first and second selection button units 115, 116. More specifically, the first selection button unit 115 is formed at the upper portion of the drink discharge opening 111, and includes a cold water button 115a, a hot water button 115b and an ice button 115c. Accordingly, through the respective buttons 115a, 115b, 115c, a customer may select cold or hot water from the cold/hot water supplying unit 130 and ice cubes from the ice making unit 160, and has his/her selected drink discharged through the drink discharge opening 111.

The second selection button unit 116 includes a plurality of disposable sachet buttons 116a, 116b, 116c through which the customer can select one from the disposable sachets stored in the disposable sachet supplying unit 140.

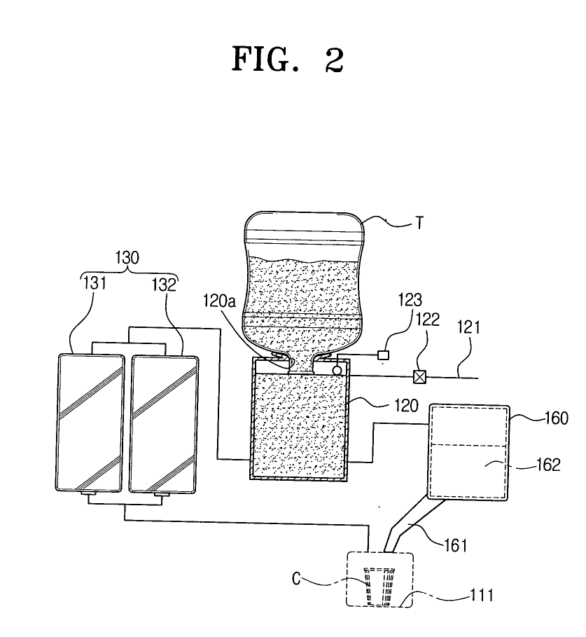

Referring now to FIG. 2, the water reservoir 120 stores a predetermined amount of water and supplies necessary water to the cold/hot water supplying unit 130 and the ice making unit 160. On the upper portion of the water reservoir 120, there may be a connecting opening 120a formed for fluidly connecting the upper portion of the water reservoir 120 with a water tank T mounted thereon. A general water tank T may be used, and as the water tank T is turned upside-down and fluidly connected to the connecting opening 120a, the water of the water tank T is supplied to the water reservoir 120 through a water pipe 121.

The water tank T may not be used. That is, instead of water tank T, a water feeding pipe 121 may be connected to an external water supply system and on the water feeding pipe 121, there is a water feeding valve 122 being disposed. As the water feeding valve 122 is opened, water is supplied from the water supply system into the water reservoir 120 through the water feeding pipe 121. The water feeding valve 122 is automatically opened and closed in accordance with the operation of a water level sensor 123 that is disposed on the water reservoir 120, to thereby supply water to a predetermined level.

The cold/hot water supplying unit 130 supplies cold and hot water, and includes a cold water tank 131 and a hot water tank 132. The cold water tank 131 is connected with the cooling unit 170 (FIG. 1), cools and stores the water from the water reservoir 120, and discharges the cold water through the drink discharge opening 111. The hot water tank 132 has a heating device such as heating wire, and heats and stores the water from the water reservoir 120, and discharges the hot water to the drink discharge opening 111.

Referring again to FIG. 1, the disposable sachet supplying unit 140 stores disposable sachets p1, p2, p3 containing different premix beverages such as coffee or tea, and each sachet p1, p2, p3 is discharged through the disposable sachet discharge opening 112 in accordance with the selection of a customer who selectively presses the disposable sachet buttons 116a, 116b, 116c.

The cup supplying unit 150 is for supplying the cups C, and stores therein a plurality of cups C being nested on each other. For use, the customer removes one from the stack of cups C of the cup supplying unit 150 through the cup discharge opening 113. A manual cup supplying unit 150 from which a customer directly extracts the cups C one by one, is preferred in terms of simple construction. However, as need arises, the cup supplying unit 150 may be constructed for automatically dispensing a single cup.

Referring again to FIG. 2, the ice making unit 160 is for supplying the ice cubes. The ice making unit 160 freezes water from the water reservoir 120 into ice cubes, stores and then discharges them to the drink discharge opening 111 through the ice discharge pipe 161. The ice making unit 160 has a predetermined volume of ice reservoir 162 therein, and automatically operated to make enough ice cubes to fill a predetermined volume of the ice reservoir 162.

Referring now to FIG. 3, the cooling unit 170 is connected with the cold water supplying unit 131 and the ice making unit 160, and includes a compressor 171, a condenser 172 and a first and a second evaporator 173a, 173b, respectively. The refrigerant, past through the compressor 171 and the condenser 172, is split into first and second expansion valves 174a, 174b, respectively. The refrigerant flowing through the first expansion valve 174a passes through a first evaporator 173a at the cold water tank 131 and returns to the compressor 171, while the refrigerant flowing through the second expansion valve 174b passes through a second evaporator 173b at the ice making unit 160 and returns to the compressor 171. The refrigerant passing the evaporators 173a, 173b undergoes heat-exchange with the ambient air of the evaporators 173a, 173b, and by the heat-exchange of the refrigerant, the water inside the cold water tank 131 is chilled and accordingly, the water fed to the ice making unit 160 is frozen to ice cubes.

Referring now to FIG. 4, the control unit 180 controls the operations of the ice making unit 160, the cold/hot water supplying unit 130 and the disposable sachet supplying unit 140. The control unit 180 may be connected with the money unit 190 and the first and second selection button units 115, 116. The control unit 180 may also be connected to the cup supplying unit 150 where that unit is electronically controlled rather than manually operated.

In response to the insertion of a predetermined amount of money through the money unit 190, the control unit 180 controls the drink dispensing apparatus 100 and places it in standby mode. The standby mode can be indicated by lighting an indicating lamp (not shown) which is provided to the first selection button unit 115 and/or the second selection button unit 116. When a customer selects through the first and second selection button units 115, 116, the control unit 180 controls the cold/hot water supplying unit 130, the ice making unit 160 and the disposable sachet supplying unit 140 to operate, thereby dispensing a drink as selected by the customer. The money unit 190 can be omitted in the case that the drinks from the drink dispensing apparatus 100 are intended to be free.

The method of operating the drink dispensing apparatus 100 according to the present invention will now be described with reference to the accompanying drawings.

With respect to the drink dispensing apparatus 100 in standby mode, the customer extracts a cup C from the stack of cups from the cup supplying unit 150 through the cup discharge opening 113 (assuming manual mode of operation), and then selects a desired sachet p1, p2, p3 by selectively pressing the disposable sachet buttons 116a, 116b, 116c of the second selection button unit 116. As the selected sachet is discharged through the disposable sachet discharge opening 112, the customer puts the premix beverage of the sachet into the cup C, and places the cup C with the premix beverage held therein in a predetermined position of the drink discharge opening 111. Next, the customer obtains the desired drink using the buttons 115a, 115b, 115c of the first selection button unit 115, to select a hot drink, cold drink, drink with ice, etc.

In the case that the drink dispensing apparatus 100 is provided with the money unit 190, a money bill or coin is inserted in the money unit 190. Determining that the inserted money is equal to or above a predetermined money value, the drink dispensing apparatus 100 is automatically placed in standby mode. When the customer overpays, change is provided after the completion of the drink dispensing, and the customer can receive the changes by using a returning lever 191.

According to the present invention, the drink dispensing apparatus 100 dispenses a premix beverage sachet, a cup, cold water, hot water, and ice cubes, and accordingly satisfies various demands of the customers who want various drinks such as cold water, hot water, water with ice, cold drink, hot drink, drink with ice, etc.

Furthermore, according to the present invention, since the premix beverage is supplied in a disposable sachet, the drink dispensing apparatus 100 can be maintained clean without having a need for frequent cleaning and it does not have any hygienic problem.

Furthermore, since the customer himself/herself extracts the cup and gets himself/herself a postmix beverage manually, the structure of the drink dispensing apparatus 100 becomes simple and manufacturing cost decreases.

Additionally, the operator of the drink dispensing apparatus 100 can flexibly dispense the drinks free or for charge, depending on the area where the drink dispensing apparatus 100 is equipped, by selectively mounting the money unit 190.

Although a few preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A drink dispensing apparatus, comprising:
a body having a drink discharge opening, a disposable sachet discharge opening, and a cup discharge opening;
a cold/hot water supplying unit mounted in the body to supply cold water and hot water through the drink discharge opening;
a disposable sachet supplying unit in the body for supplying a disposable sachet containing a premixed beverage ingredient through the disposable sachet discharge opening;
a cup supplying unit in the body for supplying a cup through the cup discharge opening;
an ice making unit in the body for supplying ice through the drink discharge opening;
a cooling unit connected to the ice making unit; and
a control unit for controlling at least the cold/hot water supplying unit, the disposable sachet supplying unit, the ice making unit, and the cooling unit.

2. The drink dispensing apparatus of claim 1, further comprising a water reservoir for supplying water to the cold/hot water supplying unit and the ice making unit.

3. The drink dispensing apparatus of claim 2, wherein the water reservoir is connected with an external water supply system through a water supply valve.

4. The drink dispensing apparatus of claim 3, wherein the water reservoir is provided with a water level sensor for sensing the water level of the water reservoir, the water level of the water reservoir being automatically adjusted in accordance with opening and closing of the water supply valve by the water level sensor.

5. The drink dispensing apparatus of claim 2, wherein the water reservoir comprises a water tank connecting opening for receiving an external water supply.

6. The drink dispensing apparatus of claim 1, further comprising a money device connected to the control unit for receiving and discharging money, whereby the control unit is entirely or partially operated only in response to the insertion of a predetermined amount of money into the money unit.

7. The drink dispensing apparatus of claim 1, further comprising a first selection button unit for selectively discharging the cold water and the hot water stored in the cold/hot water supplying unit and the ice stored in the ice making unit.

8. The drink dispensing apparatus of claim 1, further comprising a second selection button unit for selecting the disposable sachet containing a premixed beverage ingredient which is stored in the disposable sachet supplying unit.

9. The drink dispensing apparatus of claim 1, further comprising a second cooling unit connected to the cold side of the cold/hot water supply unit.

10. The drink dispensing apparatus of claim 9, further comprising a refrigeration device connected to the cooling unit and the second cooling unit.

11. A method of dispensing a drink from a drink dispensing apparatus comprising the steps of:
a. providing a drink dispensing apparatus having a drink discharge opening, a disposable sachet discharge opening, a cup discharge opening, a cold/hot water supplying unit, a disposable sachet supplying unit containing a plurality of premixed beverage ingredient sachets, a cup supplying unit, an ice making unit, a cooling unit connected to the ice making unit, and a control unit for controlling at least the cold/hot water supplying unit, the disposable sachet supplying unit, the ice making unit, and the cooling unit;
b. extracting a cup from the cup supplying unit through the cup discharge opening;
c. selecting a desired sachet
d. placing the contents of the sachet into the cup;
e. selecting a desired liquid beverage; and
f. mixing the desired liquid beverage and the contents of the sachet in the cup.

12. The method of claim 11, further comprising the step of inserting money into a money receiving apparatus connected to the control unit before selecting a cup.

13. The method of claim 11, wherein the step of selecting the sachet is done by pressing a sachet selection button on the body of the drink dispensing apparatus.

14. The method of claim 11, wherein the step of selecting the desired liquid beverage is done by pressing a beverage selection button.
